(19) United States
(12) Patent Application Publication
(10) Pub. No.: US 2021/0345853 A1
(43) Pub. Date: Nov. 11, 2021

(54) SPRAYING APPARATUS AND CONTROL METHOD THEREFOR AND DISHWASHER

(71) Applicants: FOSHAN SHUNDE MIDEA WASHING APPLIANCES MANUFACTURING CO., LTD., FOSHAN (CN); GUANGDONG MIDEA WHITE HOME APPLIANCE TECHNOLOGY INNOVATION CENTER CO., LTD., FOSHAN (CN); MIDEA GROUP CO., LTD., FOSHAN (CN)

(72) Inventors: Sen ZHANG, FOSHAN (CN); Weijun XUE, FOSHAN (CN); Wei ZHANG, FOSHAN (CN)

(21) Appl. No.: 17/285,893

(22) PCT Filed: Jun. 25, 2019
(86) PCT No.: PCT/CN2019/092730

§ 371 Date: Apr. 15, 2021

(30) Foreign Application Priority Data
Oct. 16, 2018 (CN) 201811208319.8
Oct. 16, 2018 (CN) 201811208402.5
Oct. 16, 2018 (CN) 201821682044.7
Oct. 16, 2018 (CN) 201821682091.1

(51) Int. Cl. A47L 15/22; A47L 15/42; A47L 15/46; A47L 15/00; B05B 1/20; B05B 1/04

(52) U.S. Cl. CPC A47L 15/22; A47L 15/4246; A47L 15/46; A47L 15/4282; A47L 2401/34; A47L 15/0028; B05B 1/20; B05B 1/044; A47L 2501/20; A47L 15/0086

(57) ABSTRACT

A spraying apparatus and control method therefor and a dishwasher. The spraying apparatus comprises: a spray pipe, a water injection spray pipe being provided on the spray pipe; a drive mechanism, the drive mechanism comprising a driving gear and multiple driven gears engaging with the driving gear, and the driven gear being connected to the spray pipe to drive the spray pipe to rotate; a drive mechanism, the drive mechanism being connected to the driving gear to drive the driving gear to rotate.

### CROSS-REFERENCES TO RELATED APPLICATIONS

The present disclosure is a national phase application of International Application No. PCT/CN2019/092730, filed on Jun. 25, 2019, which claims priority to Chinese Patent Application Serial Nos. 201811208402.5, 201821682044.7, 201811208319.8 and 201821682091.1, all filed on Oct. 16, 2018, the entire contents of which are incorporated herein by reference.

### FIELD

The present disclosure relates to the field of dishwashers, and more particularly to a spraying apparatus, a control method therefor, and a dishwasher.

### BACKGROUND

At present, water spray structures of dishwashers on the market usually adopt elongated spray-arm structures for rotation. Since rotation of a spray arm is driven by a motor, it is difficult to precisely control a rotation angle of the spray arm during the rotation, which is not conducive to accurate spray washing of tableware by water sprayed by the spray arm, reducing the utilization of water.

### SUMMARY

Embodiments of the present disclosure are to provide a spraying apparatus designed to improve rotation accuracy of a spray pipe to improve cleaning efficiency of the spray pipe.

In order to achieve the above embodiments, the spraying apparatus proposed by the present disclosure includes: a spray pipe provided with a water spray hole; and a drive device including a transmission mechanism and a drive mechanism, and the transmission mechanism including a driving gear and a plurality of driven gears meshing with the driving gear, the driven gears are connected to the spray pipe to drive the spray pipe to rotate, and a drive shaft of the drive mechanism is connected to the driving gear to drive the driving gear to rotate.

In one embodiment, the driven gears include a first driven gear and a second driven gear, and the first driven gear and the second driven gear are configured to mesh with both sides of the driving gear and symmetrically distributed on both sides of the driving gear; the spray pipe includes a first spray pipe and a second spray pipe, the first driven gear is connected to the first spray pipe, and the second driven gear is connected to the second spray pipe.

In one embodiment, a limiting block is arranged on a periphery of the driving gear and/or the driven gear to define an angle range of deflection of the driven gear and the spray pipe.

In one embodiment, a micro-control switch is arranged on a periphery of the driving gear and/or the driven gear and connected to a main control circuit of the spraying apparatus, and the main control circuit is electrically connected to the drive mechanism; and/or a pressure sensor is arranged on a periphery of the driving gear and/or the driven gear and connected to a main control circuit of the spraying apparatus, and the main control circuit is electrically connected to the drive mechanism.

In one embodiment, the drive device further includes a mounting housing, the mounting housing includes a front housing and a rear housing, the front housing and the rear housing are detachably connected and are snap-fitted to form a mounting cavity, and the transmission mechanism is arranged within the mounting cavity.

In one embodiment, positioning posts are arranged on and protrude from an inner wall surface of the front housing close to the rear housing, the driving gear and the driven gears are provided with mounting holes corresponding to the positioning posts, and the positioning posts are in clearance fit with the mounting holes.

In one embodiment, the transmission mechanism further includes a connecting rod; the driven gears include a first driven gear and a second driven gear; and the driving gear, the first driven gear, the connecting rod, and the second driven gear are connected in sequence for transmission; the spray pipe includes a first spray pipe and a second spray pipe, the first driven gear is connected to the first spray pipe, and the second driven gear is connected to the second spray pipe.

In one embodiment, a deflection angle α of the spray pipe is 0˜150°.

In one embodiment, the drive mechanism includes a drive motor; a drive shaft of the drive motor is connected to a shaft hole of the driving gear; and the drive motor is located on a side of the driving gear facing the spray pipe.

In one embodiment, the spray pipe includes: a pipe body having a water intake end and provided with a water spray hole in a pipe wall; and a water spray groove formed in the spray pipe at a position corresponding to the water spray hole. The water spray hole is in communication with the water spray groove, and a diameter of the water spray hole is larger than a width of the water spray groove.

In one embodiment, a ratio of the width l of the water spray groove to the diameter Φ of the water spray hole is 0.18˜0.25; and/or a ratio of a length L of the water spray groove to the diameter Φ of the water spray hole is greater than or equal to 2.5˜3.5.

In one embodiment, the water spray hole includes a water intake segment and a transition segment extending from the water intake segment to the water spray groove. The transition segment cuts a bottom of the water spray groove and extends toward a groove opening of the water spray groove

In one embodiment, an aperture diameter d at a top of the transition segment is smaller than an aperture diameter D of the water intake segment; an inner wall of the transition segment transitions from the water intake segment to a groove wall of the water spray groove in an arc shape.

The present disclosure further provides a control method for a spraying apparatus. The spraying apparatus includes spray pipe, and a pipe wall of the spray pipe is provided with a plurality of water spray holes. The control method includes: obtaining a cleaning instruction; acquiring a cleaning mode according to the cleaning instruction; and controlling the spray pipe to rotate along an axial axis of the spray pipe within a preset rotation angle range according to the cleaning mode.

In one embodiment, controlling the spray pipe to rotate within the preset rotation angle range according to the cleaning mode includes: rotating the spray pipe at a first speed within first preset duration since the spray pipe starts working; and rotating the spray pipe at a second speed within second preset duration after the first preset duration, and the first speed is greater than the second speed.

In one embodiment, the preset rotation angle range is equally divided into N cleaning zones in an angular aspect, and controlling the spray pipe to rotate within the preset rotation angle range according to the cleaning mode includes: obtaining a current cleaning zone corresponding to the spray pipe; acquiring preset spray duration at a current location according to the current cleaning zone; and controlling the spray pipe to be deflected to a next cleaning zone after the preset spray duration in the current cleaning zone.

In one embodiment, a cleaning zone corresponding to the water spray hole in a vertically upward direction is a first cleaning zone, and within the preset deflection angle range, a cleaning zone corresponding to a position where an angle between a depth direction of the water spray hole and a vertical direction is the largest is a second cleaning zone; the preset spray duration corresponding to the cleaning zone gradually increases from the first cleaning zone to the second cleaning zone.

In one embodiment, the rotation speed of the spray pipe is 10˜60 r/min.

In one embodiment, controlling the spray pipe to rotate within the preset rotation angle range according to the cleaning mode includes: obtaining a preset deflection speed according to a current cleaning mode; and rotating the spray pipe reciprocally at the preset deflection speed within the preset rotation angle range.

In one embodiment, the spraying apparatus further includes a driving gear and a driven gear, the driving gear is connected to a drive device, the driven gear is connected to the spray pipe, and a position detection device is arranged on the driving gear and/or the driven gear. Before controlling the spray pipe to rotate within the preset rotation angle range according to the cleaning mode, the control method further includes: detecting a current deflection angle of the spray pipe; comparing the deflection angle with a preset initial angle; and adjusting the deflection angle of the spray pipe when a difference between the current deflection angle and the preset initial angle is greater than zero or less than zero, to make the difference between the current deflection angle and the preset initial angle be zero.

The present disclosure further provides a dishwasher. The dishwasher includes: an inner container having a washing cavity; and a spraying apparatus configured as the spraying apparatus in any one of the above embodiments, the spraying apparatus being mounted within the washing cavity.

In one embodiment, the drive device of the spraying apparatus further includes a mounting housing, and the transmission mechanism is arranged within the mounting housing.

In one embodiment, a plurality of fixing members are arranged on an outer wall of the inner container; the fixing members include a first fixing member and a second fixing member spaced apart in a first direction; a plurality of the first fixing members are arranged at intervals in a second direction, and a plurality of the second fixing members are arranged at intervals in the second direction. The mounting housing is provided with connecting members configured to be fixed to the fixing members; the connecting members are fitted with and fixed to the fixing members; the connecting members include a first connecting member and a second connecting member spaced apart in the first direction; a plurality of the first connecting members are arranged at intervals in the second direction, and a plurality of the second connecting members are arranged at intervals in the second direction. The first direction is perpendicular to the second direction.

In one embodiment, the first fixing member is formed with a mounting groove running through the first fixing member in the first direction; the first connecting member is provided with a guide portion extending along the first direction and protruding from the first connecting member; and the guide portion is configured to be inserted into the mounting groove.

The embodiments of the present disclosure transmit a drive force of the drive mechanism to the spray pipe through the driving gear and the driven gear, so that the spray pipe rotates along its axial axis, and water is sprayed from the water spray hole on the spray pipe. During the rotation of the spray pipe, a spraying area is formed. Since the spray pipe is driven by a gear structure, the rotation and power transmission of the spray pipe are very stable and reliable. At the same time, the rotation angle of the spray pipe can be controlled very accurately, to control a change in the spraying area. As a result, the spraying apparatus can accurately control the spraying area, which is beneficial to improving the accuracy of spray-washing of the spraying apparatus for the tableware and enhancing the water utilization rate and the cleaning efficiency. Since the plurality of driven gears are driven by a single driving gear simultaneously, a single drive mechanism can drive the plurality of spray pipes at the same time, which improves the utilization rate of the drive mechanism, simplifies the transmission mechanism, saves space, enhances compactness of the drive and transmission structures of the spray pipe, and improves the stability of driving of the spray pipe.

### BRIEF DESCRIPTION OF THE DRAWINGS

In order to more clearly describe the embodiments of the present disclosure, the following will briefly introduce the drawings that need to be used in the description of the embodiments. The drawings in the following description only illustrates some embodiments of the present disclosure.

FIG. 1 is a schematic view of an embodiment of a dishwasher according to the present disclosure;

FIG. 2 is a schematic view of a water supply system of the dishwasher;

FIG. 3 is a schematic view of an embodiment of a spraying apparatus according to the present disclosure;

FIG. 4 is a schematic view of another embodiment of the spraying apparatus according to the present disclosure;

FIG. 5 is an exploded view of installation of a drive device and an inner container of the dishwasher;

FIG. 6 is a partially enlarged view at A in FIG. 5;

FIG. 7 is a cut-away view of the dishwasher;

FIG. 8 is a partially enlarged view at B in FIG. 7;

FIG. 9 is an exploded view of a first embodiment of the drive device;

FIG. 10 is an exploded view of the first embodiment of the drive device from another perspective;

FIG. 11 is an exploded view of a second embodiment of the drive device;

FIG. 12 is a schematic view of an embodiment of a spray pipe of the spraying apparatus according to the present disclosure;

FIG. 13 is a schematic view of a part of a pipe body in FIG. 12;

FIG. 14 is a cut-away view of the spray pipe in FIG. 12;

FIG. 15 is a partially enlarged view at C in FIG. 14;

FIG. 16 is a schematic view of FIG. 15 from another angle;

FIG. 17 is a schematic view of an internal structure of a cross section of the spray pipe;

FIG. 18 is a schematic view of an internal structure of a longitudinal section of the spray pipe;

FIG. 19 is a schematic view of a shape of a cross section of a water spray groove;

FIG. 20 is a schematic view of another embodiment of the spray pipe of the spraying apparatus according to the present disclosure;

FIG. 21 is a schematic view of an internal working state of FIG. 20;

FIG. 22 is a partially enlarged view at D in FIG. 21.

### REFERENCE SIGNS

| Sign | Name | Sign | Name |
|---|---|---|---|
| 10 | Inner container | 100 | Mounting housing |
| 20 | Spray pipe | 200 | Transmission |
| | | | mechanism |
| 30 | Drive device | 300 | Drive motor |
| 201 | Pipe body | 2011 | Water intake end |
| 2012 | Transmission end | 202 | Water spray groove |
| 203 | Water spray hole | 204 | Water intake segment |
| 205 | Transition segment | 206 | Bump |
| 40 | First water supply | 110 | Front housing |
| | system | | |
| 50 | Second water supply | 120 | Rear housing |
| | system | | |
| 60 | Partition plate | 210 | Driving gear |
| 11 | First tank body | 220 | Driven gear |
| 12 | Second tank body | 230 | Connecting rod |
| 13 | Sealing wall | 111 | Positioning post |
| 14 | First fixing member | 121 | First connecting |
| | | | member |
| 15 | Second fixing | 122 | Second connecting |
| | member | | member |
| 41 | First water softener | 221 | First driven gear |
| 42 | First motor pump | 222 | Second driven gear |
| 43 | First water supply | 121a | Guide portion |
| | pipe | | |
| 51 | Second water softener | 221a | First limiting block |
| 52 | Second motor pump | 222a | Second limiting block |
| 53 | Second water supply | | |
| | pipe | | |

The purpose realization, functional characteristics, and advantages of the present disclosure will be further described in conjunction with the embodiments and with reference to the accompanying drawings.

### DETAILED DESCRIPTION OF THE DISCLOSURE

The embodiments of the present disclosure will be clearly and completely described below in conjunction with the drawings in the embodiments of the present disclosure. The described embodiments are only a part of embodiments of the present disclosure, rather than all the embodiments.

It should be noted that all directional indicators (such as up, down, left, right, front, rear, etc.) in the embodiments of the present disclosure are only used to explain the relative position relationship and movement among various components in a particular posture (as shown in the accompanying drawings), and if that particular posture is changed, the directional indications will change accordingly.

In addition, descriptions involving terms “first,” “second” and the like in the present disclosure are only for illustrative purposes and cannot be understood as indicating or implying relative importance or the number of features referred to. Therefore, the features defined with “first” and “second” may explicitly or implicitly include at least one of the features. At the same time, the term “and/or” throughout the present disclosure means to include three schemes, and for example “A and/or B” includes scheme A, scheme B, or a scheme that meet both A and B.

The present disclosure proposes a spraying apparatus that is mainly applied in dishwashers to improve the water utilization rate of the dishwasher and the cleaning efficiency for tableware. The spraying apparatus includes a spray pipe 20. The spray pipe 20 is provided with a water spray hole 203 and a water spray groove 202 at the same time, and the water spray hole 203 is in communication with the water spray groove 202, so that water sprayed from the spray pipe 20 is sectorial, and when the spray pipe 20 rotates along a rotating shaft in its length direction, a cleaning plane is formed on a top of the spray pipe 20, improving the cleaning efficiency. By setting a variety of rotation modes of the spray pipe 20, working states of the spray pipe 20 can correspond to different cleaning modes to deal with different working conditions, to greatly improve the cleaning efficiency and adaptability of cleaning equipment.

A structure of the spraying apparatus will be described below.

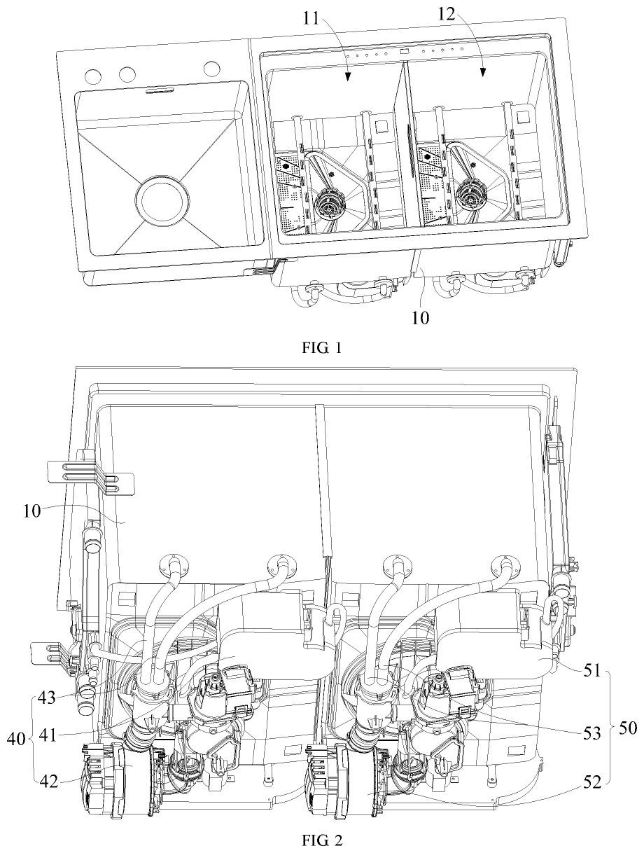

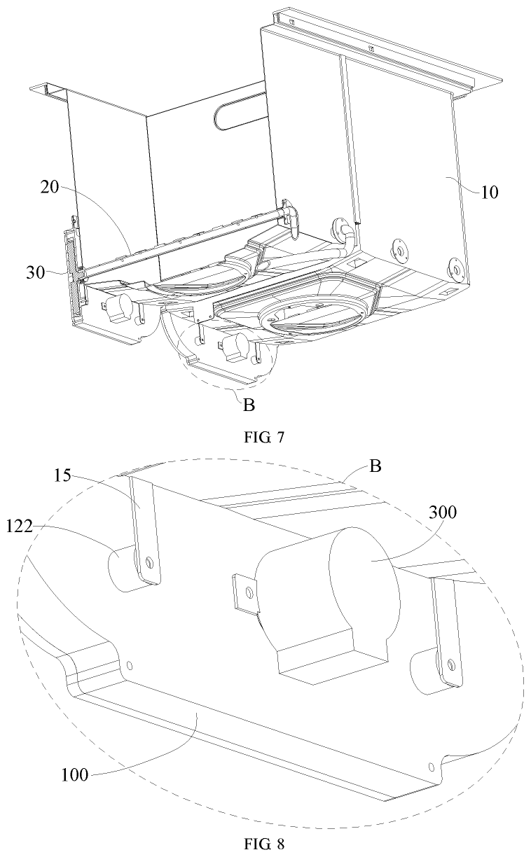

Referring to FIGS. 1-22, in the embodiment of the present disclosure, the spraying apparatus includes: a spray pipe 20 provided with a water spray hole 203; and a drive device 30 including a transmission mechanism 200 and a drive mechanism 300. The transmission mechanism 200 includes a driving gear 210 and a plurality of driven gears 220 meshing with the driving gear 210. The driven gears 220 are connected to the spray pipe 20 to drive the spray pipe 20 to rotate. The drive mechanism 300 is connected to the driving gear 210 to drive the driving gear 210 to rotate.

Since the dishwasher proposed by the present disclosure uses the spray pipe 20 instead of spray arms, and the spray pipe 20 rotates around an axis to change a spray angle and in turn a washing range, at least two beneficial effects as below can be achieved. First, the spray pipe 20 is small in size and occupies a small space, so a sink dishwasher has a large accommodating space. In addition, because the spray pipe 20 rotates around its axis, the space occupied by the spray pipe 20 is equal to its actual volume, ensuring that the sink dishwasher has a large accommodating space. Second, since the spray pipe 20 is controlled by the drive device 30, a rotation angle of the spray pipe 20 can be accurately controlled, so that a washing angle and a washing range of the spray pipe 20 can be accurately controlled, avoiding a dead angle of cleaning, and washing the tableware thoroughly.

The drive device 30 of the present disclosure can drive the spray pipe 20 to rotate, and therefore can actively control the washing angle of the spray pipe 20 to avoid the dead angle of cleaning and wash the tableware thoroughly, improving a cleaning effect of the spray pipe.

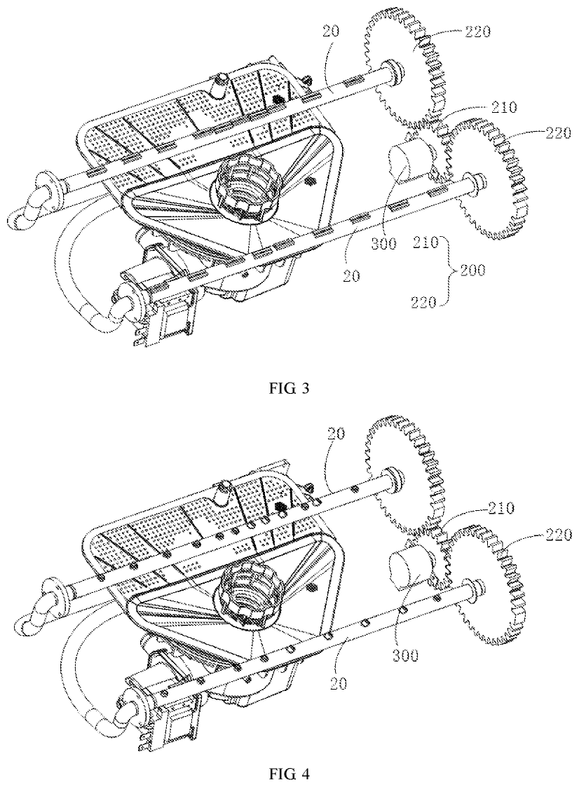

In one embodiment, as shown in FIGS. 3, 4, and 12, the spray pipe 20 is a cylindrical pipe and includes a water intake end 2011 and a transmission end 2012. That is, a water intake structure and a drive structure of the spray pipe 20 are separately arranged at both ends of the spray pipe 20, so that the drive structure and the water intake structure do not interfere with each other. The water intake end 2011 of the spray pipe 20 has a water inlet, and the transmission end 2012 thereof is closed, so that water flow can only be sprayed from the water spray hole 203. In some embodiments, in order to save space, the drive mechanism 300 and the water intake structure may also be arranged at a common end of the spray pipe 20. The transmission end 2012 of the spray pipe 20 is closed, and the water enters from the water intake end 2011 and is discharged from the water spray hole 203. The water spray hole 203 is opened on a pipe wall of the spray pipe 20, and the water flow can be sprayed directly from the water spray hole 203; or a nozzle can be installed in the water spray hole 203, and the water can be sprayed from the nozzle.

The driven gear 220 may be directly fitted over the transmission end 2012. In some embodiments, a driven rotating shaft may also be provided at the transmission end 2012, and the driven gear 220 may be fitted over the driven rotating shaft. A rotation axis of the driven gear 220 is collinear with an axial axis of the spray pipe 20. The driving gear 210 meshes with the driven gear 220, and its position relative to the driven gear 220 can be variable, for example, it may be located above, below, on the left or on the right of the driven gear. For example, the driving gear is arranged below the driven gear 220. In an example where a water spraying direction is upward, by arranging the driving gear 210 in the below, it is possible to avoid interfering with the cleaning of tableware and the like. For example, the driving gear 210 and the driven gear 220 are both spur gears. The number of driven gears 220 is multiple, and may be two, three, or even more. In an example of two driven gears, the driving gear 210 is arranged below and between the two driven gears. The driving gear 210 meshes with the two driven gears 220 at the same time. When the driving gear 210 is working, rotation directions of the two driven gears 220 are the same, so that the two driven gears 220 rotate in the same direction, and rotation directions of spray pipes 20 connected with the two driven gears 220 are the same. In this way, a plurality of spray pipes 20 driven by the same driving gear 210 can work in unison, making a cleaning pace of the spray pipes 20 consistent and improving the cleaning efficiency.

The drive mechanism 300 can have many forms, such as a motor, an impeller, a fuel engine, etc. The drive mechanism 300 has a drive shaft, and the drive shaft is directly inserted into the driving gear 210 or is connected to the driving gear 210 after being decelerated by a transmission structure. The driving gear 210 rotates with the drive shaft as a rotating shaft. The drive mechanism 300 takes a drive motor as an example, and the driving gear 210 is fixedly connected to a rotating shaft of the drive motor.

In this embodiment, a drive force of the drive mechanism 300 is transmitted to the spray pipe 20 through the driving gear 210 and the driven gear 220, so that the spray pipe 20 rotates along its axial axis, and water is sprayed from the water spray hole 203 on the spray pipe 20. During the rotation of the spray pipe 20, a spraying area is formed. Since the spray pipe 20 is driven by a gear structure, the rotation and power transmission of the spray pipe 20 are very stable and reliable. At the same time, the rotation angle of the spray pipe 20 can be controlled very accurately, to control a change in the spraying area. As a result, the spraying apparatus can accurately control the spraying area, which is beneficial to improving the accuracy of spray-washing of the spraying apparatus for the tableware and enhancing the water utilization rate and the cleaning efficiency. Since the plurality of driven gears 220 are driven by a single driving gear 210 simultaneously, a single drive mechanism 300 can drive the plurality of spray pipes 20 at the same time, which improves the utilization rate of the drive mechanism 300, simplifies the transmission mechanism 200, saves space, enhances compactness of the drive and transmission structures of the spray pipe 20, and improves the stability of driving of the spray pipe 20.

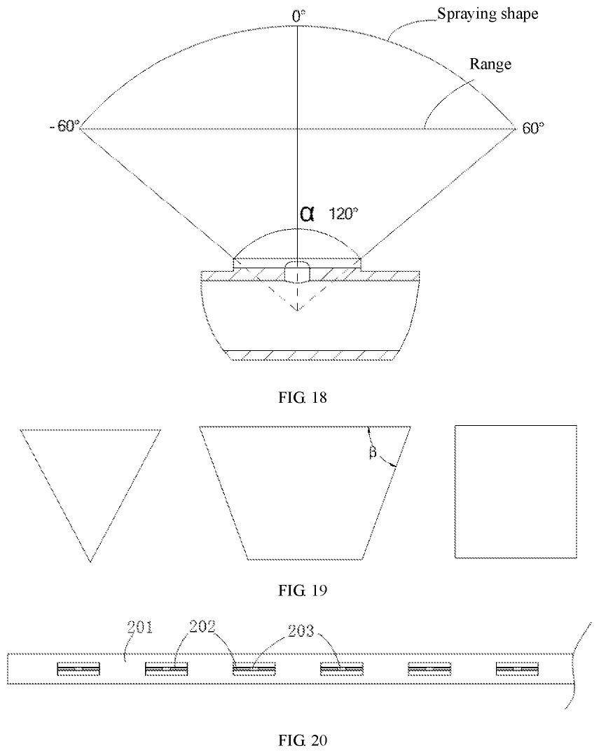

It should be noted that, in order to ensure a range of a water delivery area, as shown in FIG. 18, a deflection angle α of the spray pipe 20 is 0˜150°, such as 100˜150°. Take 120°˜140° as an example. By setting the rotation angle of the spray pipe 20 to 100˜150° or 120°˜140°, it is possible to avoid that a spraying water pressure is not enough when the angle is too large, and avoid that an area covered by the spray pipe 20 is too small to cover the entire area required for cleaning when the angle is too small.

It should be noted that regarding the deflection angle of the spray pipe 20, the angle is a central angle, i.e., an angular range where the water spray hole 203 swings by taking the axial axis of the spray pipe 20 as a center line of a circle and a distance from the water spray hole 203 to the center line as a radius. Within the deflection angle range where the water spray hole 203 swings, the water flow can always pass, and within a maximum height reached by the water flow. Taking a vertical plane that passes through the center line and bisects the water spray hole 203 as a reference plane, the deflection angle is halved by the reference plane. Taking the deflection angle of 150° as an example and taking the center line of the circle as an axis of rotation, the reference plane is deflected by 75° in left and right directions separately to form two inclined planes. An included angle between the two inclined planes is 150°, and an area between the two inclined planes is an area where the spray pipe 20 sprays water.

It should be noted that the spray pipe 20 is only a name of the pipe and is not only be used for spraying water. It can be understood that the spray pipe 20 can also spray cleaning liquid, oil and other fluids.

Regarding the positional arrangement of the driving gear 210, the driven gear 220, and the drive mechanism 300, as shown in FIGS. 3, 4, and 9-11, in some embodiments, in order to further improve space utilization and structural compactness, the number of the driven gears 220 is two, a diameter of the driving gear 210 is smaller than a diameter of each driven gear 220, and the driving gear 210 is located below the two driven gears 220. The drive mechanism 300 includes the drive motor, and the drive shaft of the drive motor is connected to a shaft hole of the driving gear 210. The drive motor is located on a side of the driving gear 210 facing the spray pipe 20.

In this embodiment, a water pump and other water supply components of the cleaning equipment (take the dishwasher as an example) are arranged under an inner container or a washing tank, and the spray pipe 20 is arranged in the inner container or the washing tank, that is, the water pump and other water supply components are arranged below the spray pipe 20. When the driving gear 210 and the drive mechanism 300 are also arranged below the spray pipe 20, the space is fully utilized, the height of the entire cleaning equipment will not be increased, and the structural compactness can be enhanced. Likewise, the drive mechanism 300 is arranged on the side of the driving gear 210 facing the water spray hole 203, so that the installation position of the drive mechanism 300 additionally increases the width of the cleaning equipment, which fully and reasonably utilizes the space and is beneficial to improving the structural compactness.

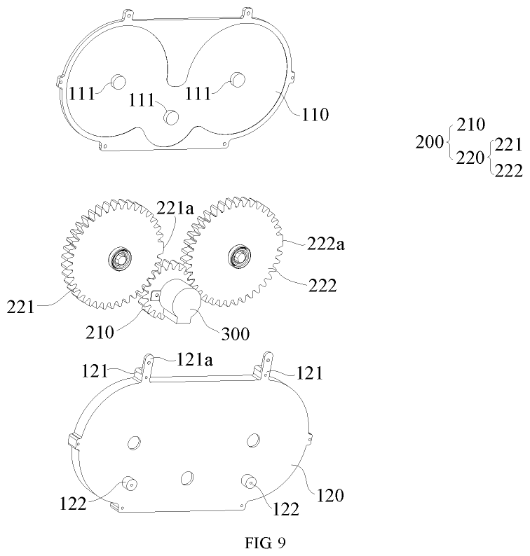

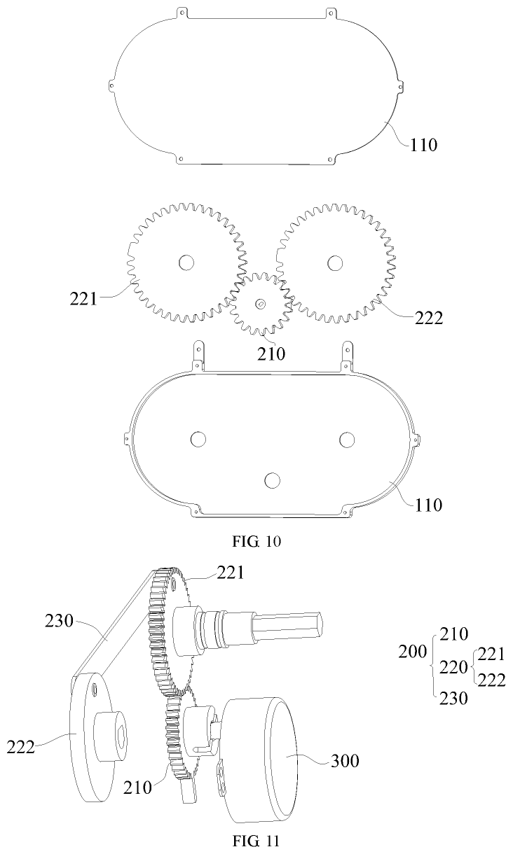

In some embodiments, as shown in FIGS. 9 and 10, the driven gears 220 include a first driven gear 221 and a second driven gear 222 that are adapted to mesh with both sides of the driving gear 210. The first driven gear 221 and the second driven gear 222 are symmetrically distributed on both sides of the driving gear 210. The spray pipes 20 include a first spray pipe and a second spray pipe. The first driven gear 221 is connected to the first spray pipe, and the second driven gear 222 is connected to the second spray pipe. Since the first driven gear 221 and the second driven gear 222 are symmetrically distributed on both sides of the driving gear 210, the first driven gear 221 and the second driven gear 222 can rotate smoothly. More importantly, since the first driven gear 221 and the second driven gear 222 are symmetrically distributed on both sides of the driving gear 210, the structure of the gear transmission mechanism 200 can become compact, realizing the miniaturization of the gear transmission mechanism 200.

However, the present disclosure is not limited thereto. In some embodiment, as shown in FIG. 11, the transmission mechanism 200 is a gear-connecting rod transmission mechanism, the driven gears 220 include the first driven gear 221 and the second driven gear 222, and the driving gear 210, the first driven gear 221, a connecting rod 230, and the second driven gear 222 are connected in sequence for transmission. The spray pipes 20 include the first spray pipe and the second spray pipe, the first driven gear 221 is connected to the first spray pipe, and the second driven gear 222 is connected to the second spray pipe.

In one embodiment, as shown in FIG. 11, a linkage mode of the gear-connecting rod transmission mechanism will be described. First, the drive mechanism 300 transmits the drive force to the driving gear 210 that is connected to the first driven gear 221, and the first driven gear 221 transmits the drive force to the second driven gear 222 through the connecting rod 230. The first driven gear 221 is connected to the first spray pipe, and the second driven gear 222 is connected to the second spray pipe, so that the drive force can be transmitted to the first spray pipe and the second spray pipe.

In some embodiments, in order to ensure that the spray pipe 20 rotates within a preset angle area to ensure the accuracy of the cleaning area, the driving gear 210 or the driven gear 220 is provided with a limiting structure that may be a mechanical structure. Through this mechanical structure, the rotation of the driving gear 210 and the driven gear 220 is physically restricted to achieve a purpose of controlling the deflection area (of the spray pipe 20) rotated by the driven gear 220. The limiting structure can be an electronically controlled sensor structure, and the sensor can be a pressure sensor, an optical sensor, a micro-control switch, etc. The sensor structure converts detected changes into voltage or current signals and transmits them to a main control circuit of the spraying apparatus. The main control circuit performs control over the drive mechanism 300 according to the received electrical signals. Here are a few examples to illustrate:

Mechanical limiting mechanism: a limiting block is provided on a periphery of the driving gear 210 and/or the driven gear 220 to limit a deflection angle range of the driven gear 220 and the spray pipe 20. The limiting block is arranged on the periphery of the driving gear 210 or the driven gear 220 and may be a square block or a special-shaped block, as long as the limiting block cannot mesh with normal teeth. In one embodiment, when the limiting block is in contact with the teeth, the teeth cannot pass over the limiting block, and instead, the teeth should be blocked by the limiting block, to restrict the driving gear 210 and the driven gear 220 from continuing to rotate relative to each other. The position of the limiting block is set according to the preset deflection angle range of the spray pipe 20. When the teeth on the driving gear 210 abut against the limiting block on the driven gear 220 (taking the limiting block arranged on the driven gear 220 as an example), the deflection angle of the spray pipe 20 at this time is a maximum deflection angle.

In one embodiment, as shown in FIG. 9, in order to enable the spray pipe 20 to stop rotating when it rotates to a boundary of the preset range, in an embodiment of the present disclosure, the first driven gear 221 is provided with a first limiting block 221a, the second driven gear 222 is provided with a second limiting block 222a, the first limiting block 221a is used to restrict a limit position of counterclockwise rotation of the driving gear 210, and the second limiting block 222a is used to restrict a limit position of clockwise rotation of the driving gear 210.

Micro-control switch for position limitation: a micro-control switch is provided on a periphery of the driving gear 210 and/or the driven gear 220. The micro-control switch is connected to the main control circuit of the spraying apparatus, and the main control circuit is electrically connected to the drive mechanism 300. During the meshing process of the driving gear 210 and the driven gear 220, when the driving gear 210 or the driven gear 220 touches or squeezes the micro-control switch, the micro-control switch can directly disconnect the power supply of the drive mechanism 300 (at this time, the micro-control switch is connected to a control circuit of the drive mechanism 300); the micro-controller can also send a disconnection signal to the main control circuit, and the main control circuit cuts off the power to the drive mechanism 300 after receiving the disconnection signal, to prevent the driven gear 220 from continuing to rotate.

Sensors for position limitation: a pressure sensor is provided on a periphery of the driving gear 210 and/or the driven gear 220. The pressure sensor is connected to the main control circuit of the spraying apparatus, and the main control circuit is electrically connected to the drive mechanism 300. The pressure sensor is connected to the main control circuit. During the meshing process of the driving gear 210 and the driven gear 220, when the teeth of the driving gear 210 or the driven gear 220 touch or squeeze the pressure sensor, the resistance of the pressure sensor changes. As a result, the current passing through the pressure sensor and the voltage loaded on the pressure sensor are changed. After an active circuit monitors such changes, the voltage of the drive mechanism 300 is cut off through a trigger circuit or a disconnection circuit, preventing the spray pipe 20 from continuing to rotate.

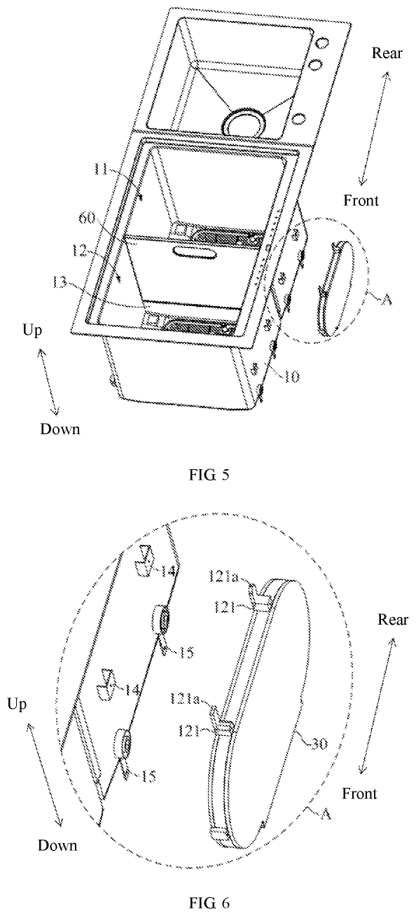

In some embodiments, referring to FIGS. 6 and 11, the transmission mechanism 200 of the drive device 30 will now be described in detail. The transmission mechanism 200 is provided with a transmission part, and the transmission end 2012 of the spray pipe 20 is provided with a mating part, and the mating part is in transmission connection with the transmission part. In this embodiment, the transmission part is a hexagonal transmission shaft fixedly arranged on the driven gear 220 of the transmission mechanism 200, the mating part is a hexagonal hole opened at the transmission end 2012, and the hexagonal transmission shaft is adapted to be inserted in the hexagonal hole.

However, the design of the present disclosure is not limited thereto. In other embodiments, the positions of the hexagonal drive shaft and the hexagonal hole can be reversed, that is, the transmission mechanism 200 is provided with a hexagonal hole, and the transmission end 2012 of the spray pipe 20 is provided with a hexagonal drive shaft. In addition, the structure of the transmission part is not limited to a hexagonal transmission shaft, but can also be a transmission shaft with a rectangular cross section, a transmission shaft with a triangular cross section, and the like. In this embodiment, a stepped shaft is also arranged between the hexagonal transmission shaft and the gear, so that the stable connection between the hexagonal transmission shaft and the gear can be ensured.

In some embodiments, as shown in FIGS. 5-10, the drive device 30 further includes a mounting housing 100, the transmission mechanism 200 is arranged within the mounting housing 100, and the drive mechanism 300 is arranged to the mounting housing 100. Since the drive mechanism 300 is arranged to the mounting housing 100 and the transmission mechanism 200 is arranged within the mounting housing 100, the modularization of the drive device 30 can be realized, and the trouble of separately installing the transmission mechanism 200 and the drive mechanism 300 can be avoided. Finally, the modularized drive device 30 can be easily installed in different installation environments, and therefore can be widely used in sink dishwashers, cabinet dishwashers, desktop dishwashers and other types of products.

In some embodiments, as shown in FIGS. 9 and 10, the mounting housing 100 includes a front housing 110 and a rear housing 120 that are detachably connected. The front housing 110 and the rear housing 120 are snap-fitted to form a mounting cavity, and the transmission mechanism 200 is arranged within the mounting cavity.

In one embodiment, a periphery of the front housing 110 is provided with a plurality of first fixing holes at intervals, and a periphery of the rear housing 120 is provided with a plurality of second fixing holes corresponding to the plurality of first fixing holes. After the first fixing holes are aligned with the second fixing holes, the front housing 110 and the rear housing 120 are detachably connected by screws or rivets.

Further, positioning posts 111 are arranged on and protrude from an inner wall surface of the front housing 110 close to the rear housing 120, the driving gear 210 and the driven gears are provided with mounting holes corresponding to the positioning posts 111, and the positioning posts 111 are in clearance fit with the mounting holes. The alignment of the positioning posts 111 and the mounting holes can facilitate the installation of the driving gear 210 and the driven gears.

Regarding the structure of the spray pipe 20, a detailed description will be given below with reference to FIGS. 3, 4, and 12-22.

A spray pipe 20 includes a pipe body 201 having a water intake end 2011 and provided with a water spray hole 203 in its pipe wall; and a water spray groove 202 formed in the spray pipe 20 at a position corresponding to the water spray hole 203. The water spray hole 203 is in communication with the water spray groove 202, and a diameter of the water spray hole 203 is larger than a width of the water spray groove 202.

In this embodiment, the pipe body 201 exhibits a columnar shape. For the structure, reference can be made to the description of the spray pipe 20 in the above embodiments, and the description herein will focus on the shapes and positions of the spray pipe 20 and the water spray groove 202. The water spray hole 203 penetrates a groove wall of the pipe body 201 so that the water in the pipe body 201 can flow out from the water spray hole 203.

A cross section of the pipe body 201 can have many shapes, such as a circle, an ellipse, a triangle, and other polygons. A circular configuration is taken as an example. A cross section of the water spray hole 203 can have many shapes, such as a circle, an ellipse, a polygon, etc., and a circular shape is taken as an example. A cross section of the water spray groove 202 can also have many shapes, such as U-shaped, trapezoidal, V-shaped, and rectangular. In the case of a water pressure and water spray hole 203, the shape of the water spray groove 202 affects the amounted of water sprayed. The water output in a case of the V-shaped water spray groove is the smallest, the water output in a case of the trapezoidal water spray groove is medium, and the water output in a case of the rectangular water spray groove is the largest. The shape of the cross section of the water spray groove 202 is set to be one of a V-shape, a trapezoid and a rectangle, and a long base of the trapezoid is close to a groove opening. That is, an end with a larger opening corresponds to the groove opening. By setting the cross section of the water spray groove 202 in a variety of shapes, the spray pipe 20 can provide different amounts of water sprayed to adapt to different working conditions, improving the adaptability of the spray pipe 20. The water spray groove 202 is arranged in an elongated shape, and the water spray groove 202 may extend along a length direction of the pipe body 201. As an example, a length direction of the water spray groove 202 is parallel to the length direction of the pipe body 201. A bottom of the water spray groove 202 is in communication with the water spray hole 203. During the operation of the spray pipe 20, the water in the pipe body 201 passes through the water spray hole 203, then enters the water spray groove 202, and spreads and is sprayed along the length direction of the water spray groove 202. In the process of water spraying, the water flow first passes through a water spray hole 203 with a large sectional area under the action of water pressure, then through an extremely narrow region (a junction between the water spray hole 203 and the water tank, and an area at this junction is smaller than an area of the water spray hole 203), and spreads in the water spray groove 202. Such a flow process causes the water flow to form a scattered water flow on an interface, and the resulting water flow resembles a sector. A projection of the sector on the pipe body 201 is parallel to the water spray groove 202 or an extension direction of the water spray groove 202, which determines a deflection angle between the sector and the length direction of the pipe body 201. If the water spray groove 202 is parallel to the length direction of the pipe body 201, a chord length of the sector is also parallel to the pipe body 201. When a plurality of water spray holes 203 and water spray grooves 202 are arranged in the length direction of the spray pipe 20, a water wall like a water jet will be formed on an interface, so that the cleaning area of the spray pipe 20 can be greatly increased. Thus, an internal section of the dishwasher will be completely covered, to achieve a comprehensive cleaning effect.

In this embodiment, through the arrangement of the water spray holes 203 and the water spray grooves 202, under the action of water pressure, the water flow enters the pipe body 201 under the action of the water pressure, and flows in the pipe body 201. When passing through the water spray holes 203, under the action of water pressure, the water enters the water spray holes 203, and enters the water spray grooves 202 after passing through the water spray holes 203. In this process, the water flow first passes through a water spray hole 203 with a larger size and then through a water spray groove 202 with a smaller size, and spreads and is sprayed in the length direction of the water spray groove 202, so that the water flow forms a water wall like a sector after being sprayed from the water spray groove 202, to form a surface cleaning along with the rotation of the spray pipe, which significantly improve the cleaning effect of the spray pipe 20 compared with the existing linear cleaning area.

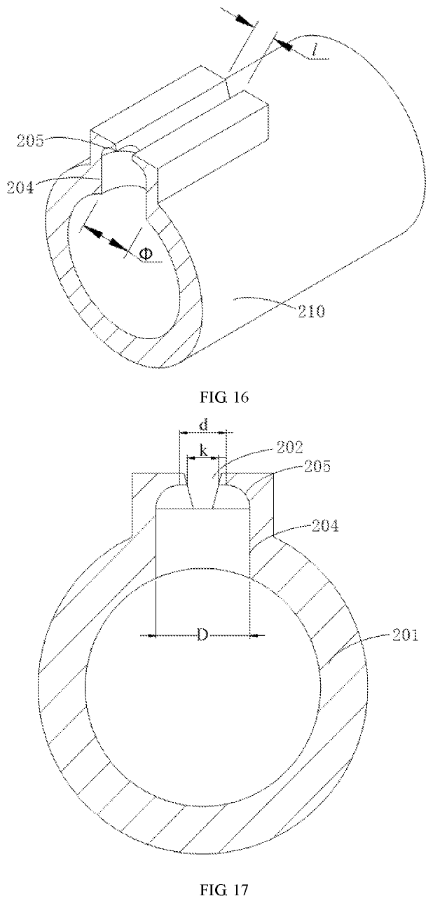

As shown in FIGS. 13 and 16, in order to further improve the cleaning effect of the water spray hole 203 and the water spray groove 202, a ratio of a width l of the water spray groove 202 to a diameter Φ of the water spray hole 203 is 0.18˜0.25, and as an example, the value of l/Φ is 0.2. The water flow enters the water spray groove 202 from the water spray hole 203, and the water pressure changes in relation to the diameter of the water spray hole 203 and the width of the water spray groove 202. When the water flow enters the water spray groove 202 from the water spray hole 203 having a large area, the water pressure increases, and the proportional relationship between the hole diameter and the width relates to the reasonable release of water energy, which affects the distance and angle of the water jet. When l/Φ is too large, the pressure difference is too small, and the distance and strength of the water jet cannot be effectively guaranteed, which may make the cleaning effect unsatisfactory; when l/Φ is too small, the width hinders the water jet, the water volume and the water speed may be diminished, which also makes the cleaning effect unsatisfactory.

In order to further improve the cleaning effect of the water spray hole 203 and the water spray groove 202, a ratio of a length L of the water spray groove 202 to the diameter Φ of the water spray hole 203 is greater than or equal to 2.5˜3.5, and as an example, the value of the ratio is greater than or equal to 3. The water flow enters the water spray groove 202 from the water spray hole 203. The diameter of the water spray hole 203 and the length of the water spray groove 202 are related to the change of water pressure. When the water flow enters the water spray groove 202 from the water spray hole 203 having a large area, the water pressure increases, and as the water flow spreads in the water spray groove along its length direction, the water pressure decreases. The proportional relationship between the diameter and the groove length relates to the reasonable release of water energy and affects the angle of the water jet. When L/Φ is too small, the groove length is not long enough for the spreading of water enters the water spray groove 202 from the water spray hole 203, so that a coverage angle of the water stream sprayed is reduced (the central angle of the sector becomes smaller), which is not conducive to spray washing of the spray pipe 20.

It should be noted that the water flow rate, spray angle and distance of the water spray groove 202 are positively correlated with the diameter of the water spray hole 203 within a range. The depth of the water spray hole 203 has an effect on the spray distance. A hole of a depth can convert energy of a lateral flow in the pipe into energy of a vertical flow, which is beneficial to long-distance spraying; for the same reason, a hole depth will increase a flow velocity sprayed, increasing a diffusion angle.

As shown in FIG. 19, when the cross-sectional shape of the water spray groove 202 is an inverted trapezoid, an inclination angle between the waist and the long base of the inverted trapezoid of the water spray groove 202 is β. According to a design of water volume, when the water volume of a single water spray groove 202 is larger, the β can be designed to be larger (that is, the cross section evolves from an inverted trapezoid to a rectangle). When the water volume distributed to a single nozzle is small, β should be designed to be smaller (that is, the cross section evolves from an inverted trapezoid to an inverted triangle). In this embodiment, β is 15˜25°, and as an example, β is 20°. In one embodiment, an angle between a groove wall surface of the water spray groove 202 and a plane where the groove opening is located is β, and β is 15˜25°.

In order to meet the requirements of different working conditions, different shapes of water spray grooves 202 can be arranged on the same spray pipe 20, which will be described in detail below.

A plurality of the water spray holes 203 and a plurality of the water spray grooves 202 are provided and correspondingly arranged, and the cross-sectional shapes of the plurality of water spray grooves 202 are set to be one or more kinds of a V shape, a trapezoid shape and a rectangular shape. In this embodiment, the water spray holes 203 and the water spray grooves 202 are in one-to-one correspondence. In some embodiments, one water spray groove 202 may correspond to the plurality of water spray holes 203, that is, the water spray groove 202 is a long groove, and the plurality of water spray holes 203 are arranged at the bottom of the water spray groove 202. The shape of the cross section of the water spray groove 202 can have various forms in the same spray pipe 20, that is, the angle between the groove wall surface of the water spray groove 202 and the plane where the groove opening is located can take various values. In some working conditions, the amount of water and flushing intensity required for different positions are different, which at this time can be achieved by changing the shape of the water spray groove 202 or adjusting the angle β.

In some embodiments, it is necessary to distinguish among strong, medium, and weak spraying areas to clean the objects to be cleaned with different degrees of cleanliness and improve cleaning efficiency. The cross section of the water spray groove 202 in the middle of the spray pipe 20 is rectangular or trapezoidal; and the cross sections of the water spray grooves 202 at both ends of the spray pipe 20 are trapezoidal or V-shaped. In such a case, the middle part is a strong cleaning zone, and the two ends of the spray pipe 20 are medium cleaning zones or weak cleaning zones. Thus, it is beneficial to efficiently cleaning the tableware to be cleaned with different cleanliness levels at the same time.

In some embodiments, as the water is sprayed, the water pressure at the water intake end 2011 of the spray pipe 20 is different from that at the transmission end 2012 thereof, resulting in different water spraying effects at both ends. In order to make the water spraying effects at different positions of the spray pipe 20 uniform, the cross section of the water spray groove 202 close to the water intake end 2011 of the spray pipe 20 is V-shaped, the cross section of the water spray groove 202 in the middle of the spray pipe 20 is trapezoidal, and the water spray groove 202 far away from the water intake end 2011 of the spray pipe 20 is rectangular. In this way, the water spray groove 202 farther from the water intake end 2011 can also spray a larger amount of water flow.

In order to make full and reasonable use of water energy and further improve the spraying effect, as shown in FIGS. 15-17, the water spray hole 203 includes a water intake segment 204 and a transition segment 205 extending from the water intake segment 204 to the water spray groove 202. The transition segment 205 cuts the bottom of the water spray groove 202 and extends toward the groove opening of the water spray groove 202. In one embodiment, in this embodiment, the cross section of the water spray hole 203 exhibits a circular shape as an example, and the transition segment 205 extends toward the groove opening and cuts the groove bottom. When the cross section of the water spray groove 202 is arranged in a V-shaped or inverted trapezoid shape, the width at the junction of the water spray hole 203 and the water spray groove 202 is greater than the width of the bottom of the water spray groove 202. Through the arrangement of the transition segment 205, the depth of the water spray hole 203 is shifted to the groove opening, and an entrance area of the water from the water spray hole 203 into the water spray groove 202 is increased, so that the water will not be lost a lot in the process of flowing, and instead enter the water spray groove 202 from a position of a side wall of the groove, so that the energy of the water flow can be effectively retained, and the distance and deflection angle of the water sprayed from the groove can be greatly increased, which is beneficial to improving the cleaning efficiency of the spray pipe 20.

In some embodiments, in order to further increase the spraying effect, as shown in FIG. 17, an aperture diameter d at the top of the transition segment 205 is smaller than an aperture diameter D of the water intake segment 204. When the water flow passes through the water intake segment 204 with the larger diameter to the transition segment 205 with the smaller diameter, the water pressure increases while the water flow is guided for transition, which is beneficial to increasing the spray distance and range.

In the transition process, in order to avoid energy loss due to large friction and collision between the water flow and the hole wall, an inner wall of the transition segment 205 transitions from the water intake segment 204 to a groove wall of the water spray groove 202 in an arc shape. In this way, when the water flow enters the transition segment 205 from the water intake segment 204, and enters the water spray groove 202 from the transition segment 205, the water flow is smoothly guided, which is beneficial to retaining the water energy.

In order to further improve the water spraying effect of the water spray groove 202, a groove width at an intersection of the top of the transition segment 205 and the water spray groove 202 is k, and the aperture diameter d is greater than or equal to twice the k. In this embodiment, by setting the aperture diameter d to be greater than or equal to twice the groove width k, a change in the water pressure from the transition segment 205 into the water spray groove 202 can be guaranteed, the pressure difference is ensured, and the water flow can enter the water spray groove 202 more stably, reliably and efficiently, and extend and be sprayed along the length of the water spray groove 202, which is beneficial to increasing the spray distance and spray angle.

There are many ways to form the water spray groove 202. The water spray groove 202 can be formed directly on the pipe body 201 or can be formed by arranging other structures on the pipe body 201, which will be elaborated below.

The water spray groove 202 is opened on an outer side wall of the pipe body 201. The water spray groove 202 is directly opened on the outer side wall of the pipe body 201, and the water spray groove 202 extends along the length direction of the pipe body 201. This arrangement simplifies the formation process of the water spray groove 202, does not require additional components, and reduces the assembly process. At the same time, the water spray groove 202 sinks into the pipe body 201, so that external environmental factors are difficult to affect the operation of the water spray groove 202, which is beneficial to improving the stability of the water spray groove 202 in operation.

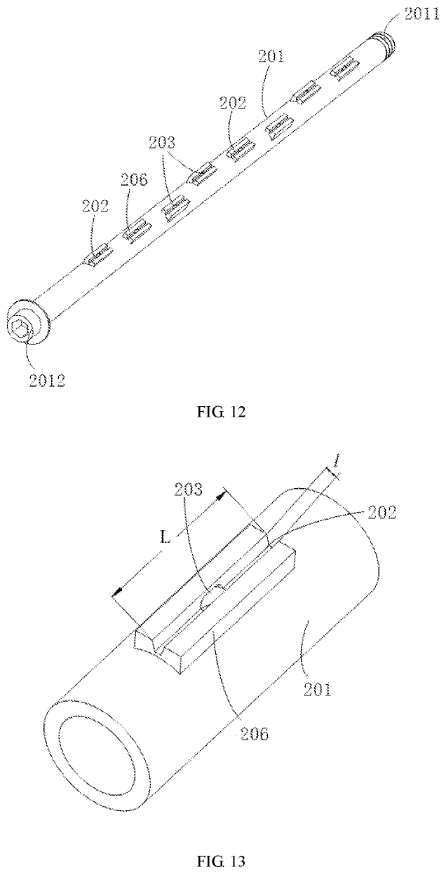

In some other embodiments, as shown in FIGS. 12-14, the spray pipe 20 further includes a bump 206 arranged on the outer side wall of the pipe body 201 corresponding to the water spray hole 203, and the water spray groove 202 is formed on the bump 206. There may be many forms of the bump 206, such as an elongated bump 206, a square bump 206, a round bump 206, etc., and the elongated bump 206 is taken as an example. The water spray groove 202 is opened on the bump 206, and the bottom of the water spray groove 202 is connected to the outer side wall of the pipe body 201. In some embodiments, the bump 206 can be integrally formed with the pipe body 201. In this way, the connection process between the bumps 206 and the pipe body 201 can be greatly simplified, and the production efficiency of the spray pipe 20 can be improved. By arranging the water spray groove 202 on the bump 206, in a case that the pipe body 201 is the same, it is equivalent to an increase in the thickness of the pipe wall, which is beneficial to ensuring the strength of the spray pipe 20 when the spray pipe is provided with the water spray hole 203 and is conductive to prolonging the service life of the spray pipe 20.

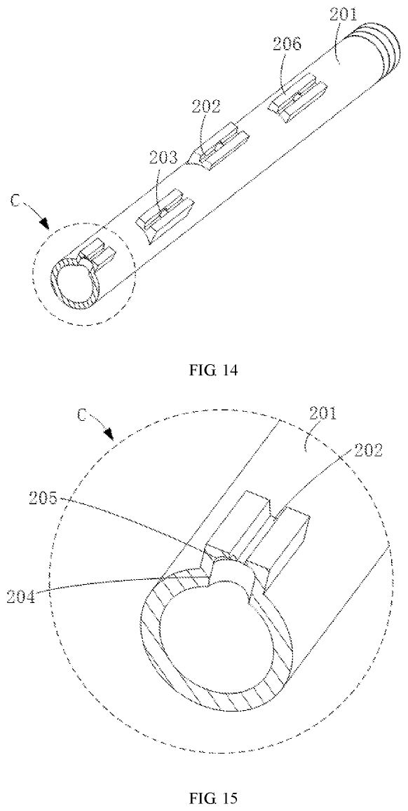

In some embodiments, in order to make more reasonable use of water energy, prevent water jets from adjacent water spray grooves 202 from colliding and avoid wasting water energy, the number of water spray grooves 202 is multiple, and the water spray grooves 202 extend along the length direction of the pipe body 201. The plurality of water spray grooves 202 are arranged in an S shape along the length direction of the pipe body 201, as shown in FIGS. 12 and 14.

It should be noted that the number of water spray grooves 202 arranged in an S shape is not limited, and may be three, four, five, etc., that is, there may be only one S shape on the spray pipe 20, or a plurality of S shapes may appear at the same time. That is, a connecting line of two adjacent water spray holes 203 is neither consistent with the length direction of the pipe body 201, and nor consistent with the length direction of the water spray groove 202. With this arrangement, when the deflection angle range of the water spray groove 202 is large, the projections of the two adjacent sectorial spraying areas on the pipe body 201 are not collinear, so that the water sprayed from the two adjacent water spray grooves 202 will not intersect, avoiding the collision of the water sprayed by two adjacent water spray grooves 202 and causing water energy loss. In this way, when the deflection angle of water sprayed by each water spray groove 202 is large enough, some cleaning areas of the spray pipe 20 will undergo secondary washing, that is, during a single one-way rotation of the spray pipe 20, there will be two water walls to wash the same area, which can greatly improve the cleaning efficiency of the spray pipe 20.

It can be understood that the present disclosure is not limited thereto. For example, as shown in FIG. 20, a plurality of water spray grooves 202 are arranged in sequence along the length direction of the pipe body 201, that is, a connecting line between two adjacent water spray grooves 202 is consistent with the length direction of the pipe body 201.

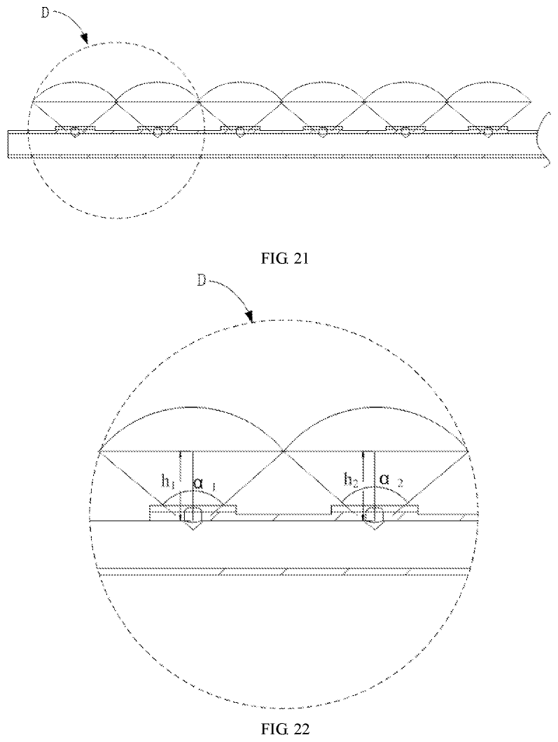

As shown in FIGS. 21 and 22, in order to ensure the cleaning effect while avoiding the waste of water energy, a height of the water sprayed by a first water spray groove 202 is h₁, and a central angle corresponding to the sectorial spraying area is α₁; a height of the water sprayed by the second water spray groove 202 adjacent to the first water spray groove 202 is h₂, and a central angle corresponding to the sectorial spraying area is α₂.

A distance between adjacent a first water spray hole 203 and a second water spray hole 203 is greater than 0 and is less than or equal to: h₁ tan(α₁/2)+h₂ tan(α₂/2).

Regarding the positional relationship between adjacent spray pipes, it is not only applicable to this embodiment, but also applicable to other embodiments.

Among them, α₁ and α₂, as well as h₁ and h₂, are affected by factors such as processing, manufacturing and assembling of the water spray hole 203 and the water spray groove 202, an included angle with the pipe body 201, and a distance from the water intake end 2011 of the pipe body 201. When α₁=α₂ and h₁=h₂, the distance between two adjacent water spray holes 203 is less than or equal to: 2h₁ tan(α₁/2) or 2h₂ tan(α₂/2).

By setting the distance between two adjacent water spray holes 203 in this way, it can be ensured that adjacent cleaning areas intersect, and hence the cleaning plane formed when the spray pipe 20 rotates is a continuous plane, to achieve no dead-angle cleaning.

Regarding the distance between the first water spray hole 203 and the second water spray hole 203, the actual situation has different actual parameters, and the parameters can be adjusted according to the actual disclosure. Some embodiment of the parameters are described below. In some embodiments, the distance between the first water spray hole 203 and the second water spray hole 203 is 20 mm to 30 mm. Similarly, the number of water spray holes 203 on each spray pipe 20 should also be determined according to actual conditions. In some embodiments, the number of water spray holes 203 on each spray pipe 20 is eight to ten.

In some embodiments, in order to ensure the cleaning effect of the spray pipe 20, if the total circulating water volume is M, the flow velocity of the water in the water spray holes 203 is V, the total number of water spray holes 203 is N, and the cross-sectional area of the water spray hole 203 is S, then M*V≥N*S/2. That is, M≥N*S/(2 V). When the spraying apparatus is formed, the total number N of water spray holes 203 and the cross-sectional area of the water spray hole 203 are fixed, and the total circulating water volume can be set according to the required water velocity.

Among them, V≥(N*S/2)/M, and M/N is the water spray volume of a single spray pipe. The flow velocity of V≥½ (m/s) is taken as an example.

There are many types of cleaning equipment, such as dishwashers, fruit and vegetable cleaning equipment, etc. The cleaning equipment includes an inner container 10 and a spraying apparatus. The structure of the spraying apparatus refers to the above-mentioned embodiments. Since the cleaning equipment adopts the above-mentioned embodiments, it at least has all the beneficial effects caused by the above-mentioned embodiments, which will not be repeated here. The inner container 10 has a washing cavity, and the spray pipe 20 of the spraying apparatus is installed in the washing cavity.

In some embodiments, referring to FIGS. 6-8, an installation structure of the drive device 30 and the inner container 10 will now be described in detail. A plurality of fixing members are arranged on an outer wall of the inner container 10, and the mounting housing 100 is provided with connecting members adapted and fixed to the fixing members, and the connecting members cooperate with and are fixed to the fixing members.

In one embodiment, as shown in FIG. 6, the fixing members include a first fixing member 14 and a second fixing member 15 spaced apart in a first direction; a plurality of the first fixing members 14 are arranged at intervals in a second direction, and a plurality of the second fixing members 15 are arranged at intervals in the second direction. The connecting members include a first connecting member 121 and a second connecting member 122 spaced apart in the first direction; a plurality of the first connecting members 121 are arranged at intervals in the second direction, and a plurality of the second connecting members 122 are arranged at intervals in the second direction. The first direction is perpendicular to the second direction. In this embodiment, the first direction is an up-down direction, and the second direction is a front-rear direction. Since a plurality of the fixing members and a plurality of the connecting members are arranged at intervals in the up-down direction and the front-rear direction, the stability of the drive device 30 and the inner container can be ensured after installation.

In an embodiment of the present disclosure, the first fixing member 14 is formed with a mounting groove running through in the first direction. The first connecting member 121 is provided with a guide portion 121a extending along the first direction and protruding from the first connecting member. The guide portion 121a is fitted and inserted into the mounting groove. The installation of the guide portion 121a and the mounting groove has a positioning function, and in this way, the installation of the drive mechanism and the inner container 10 can be facilitated.

In one embodiment, an installation process of the drive mechanism 300 and the inner container 10 will now be described in detail. First, the guide portion 121a is inserted into the mounting groove. After the guide portion 121a is installed in place in the mounting groove, the first fixing member 14 is aligned with a mounting hole on the first connecting member 121, and the second fixing member 15 is aligned with a mounting hole on the second connecting member 122. At this time, the drive mechanism 300 can be mounted on the outer wall of the inner container 10 by inserting screws or rivets into the mounting holes.

In some embodiments, referring to FIG. 1 and FIG. 2, in order to obtain different cleaning effects, in an embodiment of the present disclosure, the inner container 10 has a plurality of washing zones, and each washing zone is correspondingly provided with a water supply system. Since different washing zones are connected to different water supply systems, different water supply systems can be set to different washing intensities, so that different washing zones can realize cleaning at different intensities.

In an embodiment of the present disclosure, the inner container 10 includes a plurality of tank bodies that are portioned from each other, and each of the tank bodies forms one washing zone. In this embodiment, the inner container 10 includes a first tank body 11 and a second tank body 12 that are arranged in a partitioned manner. A first washing zone is formed in the first tank body 11, and a second washing zone is formed in the second tank body 12. The water supply systems include a first water supply system 40 and a second water supply system 50. The first water supply system 40 is arranged corresponding to the first washing zone, and the second water supply system 50 is arranged corresponding to the second washing zone.

The first washing zone can be set as a normal washing zone, and the second washing zone can be set as a strong washing zone. The water supply system may be a dual waterway system, and in the dual waterway system, the strength of the first water supply system 40 and the strength of the second water supply system 50 are set differently. Therefore, partition of strong and weak zones can be realized in a single washing process, so that users can clean tableware with different degrees of dirtiness in a targeted manner.

In addition, the tableware can also be washed in different degrees through successively passing washing zones of different strengths. In one embodiment, the tableware to be cleaned can first enter the strong washing zone for washing to flush away food residues, and then enter the normal washing zone for washing to clean oil stains thoroughly.

However, the design of the present disclosure is not limited thereto. In other embodiments, the first tank body 11 and the second tank body 12 may also be arranged in communication with each other, so that the tableware can be conveniently transferred from the strong washing zone to the normal washing zone.

Further, referring to FIG. 5, in order to conveniently change a volume of an accommodating space of the inner container 10, in an embodiment of the present disclosure, the inner container 10 is provided with a movable partition plate 60, so that the inner container 10 can be divided into the first tank body 11 and the second tank body 12. When the partition plate 60 is installed, the partition plate 60 can divide the inner container 10 into the first tank body 11 and the second tank body 12. When the partition board 60 is removed, the first tank body 11 is in communication with the second tank body 12, so that the inner container 10 can accommodate tableware having a large volume, such as pots, large plates, and the like.

The movable installation of the partition plate 60 will now be described in detail. In this embodiment, the inner wall surface of the inner container 10 is provided with a sliding groove extending in the up-down direction, and the partition plate 60 can be installed in the sliding groove in a sliding manner. In one embodiment, an upper part of the partition plate 60 is provided with a clasp groove, so that the partition plate 60 can be easily drawn.

Further, still referring to FIG. 5, in order to improve the sealing performance of the partition plate 60 and avoid water leakage from the partition plate 60, in an embodiment of the present disclosure, a bottom wall of the inner container 10 is provided with a sealing wall corresponding to the partition plate 60 and protruding from the bottom wall. The bottom of the partition plate 60 is sealed against the sealing wall. After the sealing wall is installed, the position of the partition plate 60 can be raised, reducing the water pressure at the joint between the partition plate 60 and the inner container 10, to enhance the sealing performance of the partition plate 60 and prevent water in the first tank body 11 and the second tank body 12 from flowing around.

In one embodiment, the top of the sealing wall is provided with a recess, and the bottom of the partition plate 60 is fitted and embedded in the recess. In this way, not only the sealing performance of the partition plate 60 can be further improved, but also the connection strength between the partition plate 60 and the inner container 10 can be enhanced.

Further, the installation structure of the water supply systems will now be described. In this embodiment, the partition plate 60 is arranged in the middle of the inner container 10, the first water supply system 40 is arranged on an outer wall surface of a bottom wall of the first tank body 11, and the second water supply system 50 is arranged on an outer wall surface of a bottom wall of the second tank body 12. The first water supply system 40 and the second water supply system 50 are symmetrically arranged with respect to a plane where the partition plate is located. Since the partition plate 60 is located in the middle of the inner container 10, the structures of the first tank body 11 and the second tank body 12 are symmetrical, and the first water supply system 40 and the second water supply system 50 have similar structures and the same weight, the structure of the dishwasher can become symmetrical and stable by mounting the first water supply system 40 on the bottom wall surface of the first tank body 11 and mounting the second water supply system 50 on the bottom wall surface of the second tank body 12.

Further, referring to FIG. 2, in order to make the structure of the dishwasher more stable, in an embodiment of the present disclosure, a water softener and a motor pump of the water supply system are arranged on a diagonal line of the bottom wall of the tank body, and a water cup assembly of the water supply system is located between the water softener and the motor pump. In one embodiment, the first water supply system 40 includes a first water softener 41, a first water cup assembly, a first motor pump 42, a first water supply pipe 43, and a first connecting pipe connected in sequence; the first connecting pipe makes the first water softener 41, the first water cup assembly, and the first motor pump 42 communicated with one another; the first motor pump 42 and the first water softener 41 are arranged on a diagonal of the bottom wall of the first tank body 11; and/or the second water supply system 50 includes a second water softener 51, a second water cup assembly, a second motor pump 52, and a second connecting pipe connected in sequence; the second connecting pipe makes the second water softener 51, the second water cup assembly and the second motor pump 52 communicated with one another; the second motor pump 52 and the second water softener 51 are arranged on a diagonal of the bottom wall of the second tank body 12.

Further, still referring to FIG. 2, in order to make the arrangement of the first water supply system 40 and the second water supply system 50 more compact, in an embodiment of the present disclosure, the first water supply system 40 and the second water supply system 50 are arranged in a staggered manner. In one embodiment, the first water softener 41 extends to a side of the second water supply system 50; and/or, the second motor pump 52 extends to a side of the first water supply system 40.

In one embodiment, the water supply system further includes a pressure holding pipe communicating the motor pump and the water supply pipe. A diameter of the pressure holding pipe is larger than a diameter of the water supply pipe, so that the water pressure of the water supply pipe can be more stable.

In order to meet people's needs, some control methods adapted to different working conditions will be disclosed below, and refer to the following embodiments.

A control method for a spraying apparatus is provided. The spraying apparatus includes a spray pipe 20. Several water spray holes 203 are arranged on a pipe wall of the spray pipe 20. A water flow enters the spray pipe 20 from a water intake end 2011 of the spray pipe 20 and is sprayed from a water spray hole 203 of the spray pipe 20. The control method for the spraying apparatus includes: obtain a cleaning instruction.

There are many ways to obtain the cleaning instruction. For example, a user sends a cleaning instruction through a mobile terminal or presses a button manually, or the cleaning equipment can be triggered to send the cleaning instruction automatically when a condition is satisfied during a working process. Among them, the condition may be that the washing cavity is detected as having objects to be cleaned, and there are various detection methods, such as infrared sensors, gravity sensors and so on. In some embodiments, in order to improve the control accuracy, it is possible to detect, before cleaning, whether the cleanliness of the objects to be cleaned meets the cleanliness standards of tableware.

The control method for the spraying apparatus includes: obtaining a cleaning mode according to the cleaning instruction.

The cleaning instruction can be a single start instruction or an instruction carrying mode information. When the instruction is an instruction carrying mode information, the spraying apparatus searches in a corresponding mapping table according to the corresponding mode to perform control based on parameters acquired in the mapping table. The mapping table is a preset relation table between the modes and working references of the spraying apparatus. When there is no mode information in the cleaning instruction, a detection device can detect a current working condition, or the current time can be obtained, to control the working parameters according to a detection result or control the working parameters according to the current time information. The cleaning modes corresponds to the cleaning conditions, which can be fixedly set to be strong wash, weak wash, and medium wash, or can be a cleaning mode set to improve the cleaning effect.

According to the cleaning mode, the spray pipe 20 is controlled to rotate along its axial axis within a preset rotation angle range.

The spray pipe 20 rotates along its longitudinal axis, and the axial axis of the spray pipe 20 passes through the interior of the spray pipe 20. As an example, the axial axis passes through a center of its cross section. For the preset rotation angle range, please refer to the deflection angle mentioned in the above embodiments. The preset rotation angle range is 0˜150°, and 120° is taken as an example for description. As an example, a plane passing through a center line of a circle and the water spray hole 203 bisects the rotation angle range, and a range of rotation angle of 60° is on each side of the plane, that is, the water spray hole 203 can be rotated in two ranges of 60° on the left and on the right, or rather an included angle between an orientation of the water spray hole 203 and the plane can be any value from −60° to 60° during the working process.

In this embodiment, the cleaning instruction is first obtained, then the cleaning mode is obtained according to the cleaning instruction, and the spray pipe 20 is controlled to rotate along its axial axis within a preset rotation angle range according to the cleaning mode, so that the rotation of the spray pipe 20 is limited to the preset range, avoiding idle work of the spray pipe 20 (that is, the water sprayed by the spray pipe 20 is not sprayed on the objects to be cleaned or a designated washing zone), and improving the cleaning efficiency of the spray pipe 20. Since the spray pipe 20 is configured to rotate along its axial axis, the space required for the rotation of the spray pipe 20 is very small, and the phenomenon of jamming will not easily occur, which is beneficial to improving the stability of the spray pipe 20. For a non-circular washing cavity, the spray pipes 20 can be arranged according to the shape of the washing cavity. Compared with the water spray of the rotating spray arm, the self-rotating water spray of the spray pipe 20 is beneficial to increasing the coverage area and cleaning dead corners, to improve the cleaning effect.

The process of washing the objects to be cleaned includes several stages. Much dirt exists at the first stage. At this time, high-frequency washing is required to clean most of the dirt, leaving only the dirt that is more difficult to clean. At the second the stage, for the dirt that is more difficult to clean, continuous long-term washing is required. For the dirt that is more difficult to clean, continuous long-term washing is more conducive to improving the cleaning effect. In one embodiment, the step that the spray pipe 20 is controlled to rotate within the preset angle range according to the cleaning mode includes: rotating the spray pipe 20 at a first speed within first preset duration since the spray pipe 20 starts working; and rotating the spray pipe 20 at a second speed within second preset duration after the first preset duration, in which the first speed is greater than the second speed.

The rotation speed of the spray pipe 20 is 10˜60 r/min (revolution per minute, that is, the number of revolutions in one minute), and 10˜40 r/min is taken as an example. During the first preset duration at the beginning of cleaning, the first preset duration lasts 5˜10 minutes as an example, the spray pipe 20 rotates at a first speed, and the first speed is 40 r/min as an example; during the second preset duration that lasts 6˜8 minutes for example, the spray pipe 20 rotates at a speed of 20 r/min. A large amount of dirt is first cleared by high-frequency rotation and then dirt that is more difficult to clean is cleared by long-term washing, so that the cleaning effect of the spraying apparatus can be improved.

In some embodiments, in order to improve the cleaning effect, the preset rotation angle range is equally divided into N cleaning zones in an angular aspect. The step of controlling the spray pipe 20 to rotate within the preset rotation angle range according to the cleaning mode includes: obtaining a current cleaning zone corresponding to the spray pipe 20; acquiring preset spray duration at a current location according to the current cleaning zone; and controlling the spray pipe 20 to be deflected to a next cleaning zone after the preset spray duration in the current cleaning zone.

In this embodiment, the rotation angle range is first divided into a plurality of cleaning zones. The range of each cleaning zone is determined by a rotation angle. The range of each cleaning zone can be the same or different, and can be set according to the actual situations. For example, the rotation angle range is 120°, and a plurality of cleaning zones are provided. The rotation angle range of 120° is divided into 30 equal parts for example, and each equal part corresponds to one cleaning zone, and a central angle corresponding to a range of each cleaning zone is 4°.

The spray duration of the spray pipe 20 in each cleaning zone can be the same or different according to actual needs. For example, the spray duration of each cleaning zone is the same and lasts 4-6 seconds (e.g., 5 seconds). When the spray duration of each cleaning zone is not necessarily the same, it is first necessary to obtain a current position of the spray pipe 20, i.e., the corresponding cleaning zone or the deflection angle, and then the accurate cleaning duration is acquired based on the angle information or the information on the cleaning zone. In one embodiment, the angle range and position included in each cleaning zone, and the corresponding cleaning duration can be pre-stored in a storage device of the spraying apparatus in the form of a mapping table. After the spray pipe 20 stays for a period of time corresponding to the corresponding cleaning zone, the spray pipe continues to rotate and rotate to the next cleaning zone to perform cleaning in the next cleaning zone.

In the above cleaning process, it can be understood that when cleaning a cleaning zone, the spray pipe 20 can be controlled to rotate or stand still according to the actual situations. In some embodiments, the spray pipe 20 can be controlled to shift back and forth within a small cleaning zone. This situation usually occurs when a cleaning range of a single cleaning position of the spray pipe 20 cannot cover the entire cleaning zone.

In some embodiments, in order to ensure the cleaning effect, considering that the deflection angle of the spray pipe 20 is different, the water delivery distance and the cleaning intensity of the spray pipe 20 will change. A cleaning zone corresponding to the water spray hole 203 in a vertically upward direction is a first cleaning zone, and within the preset deflection angle range, a cleaning zone corresponding to a position where the angle between a depth direction of the water spray hole 203 and the vertical direction is the largest is a second cleaning zone.

The preset spray duration corresponding to the cleaning zone gradually increases from the first cleaning zone to the second cleaning zone.

In this embodiment, the parameters of the above embodiment are taken as an example for further illustration. For example, an angler range covered by the cleaning zone in the vertically upward direction (i.e., the first cleaning zone) is −2˜2°, then an angler range covered by the second cleaning zone (two zones with the largest deflection angle) is 56˜60° or −56˜−60°. There are many ways to increase the spray duration, such as increasing linearly, increasing according to a preset curve, and the like. In this embodiment, the spray duration for each cleaning zone is increased by 0.05 to 0.3 seconds, for example, by 0.1 second. If the length of stay in the first cleaning zone is 4 seconds, the spray duration in the cleaning zone adjacent to the first cleaning zone is 4.1 seconds, so calculated, the spray duration in the second cleaning zone is 4+15*0.1 second, which is 5.5 seconds. In this embodiment, the spray duration is increased when the deflection angle is large, to ensure the cleaning effect of each cleaning zone, which is beneficial to improving the cleaning effect of the spraying apparatus.

In some embodiments, in order to improve the working stability of the spray pipe 20, the step of controlling the spray pipe 20 to rotate within the preset rotation angle range according to the cleaning mode includes: obtaining a preset deflection speed according to a current cleaning mode; and rotating the spray pipe 20 reciprocally at the preset deflection speed within the preset rotation angle range.

In this embodiment, the deflection speed serves as a working parameter of the spray pipe 20, which corresponds to the cleaning mode. The working conditions involved in different cleaning modes are different, and different deflection speeds are also required, which is not limited herein and is 10˜40 r/min for example. In the range of −60˜60°, the spray pipe rotates differently, deflecting from 0° in the vertically upward direction to a position of 60°, then rotating from the position of 60° to 0°, then to a position of −60°, and so on. This arrangement makes the rotation rule of the spray pipe 20 very simple and the operation of the spray pipe 20 very stable.

In some embodiments, in order to obtain an initial position of the spray pipe 20 more accurately, and ensure the normal operation of the spraying apparatus, the spraying apparatus further includes a driving gear 210 and a driven gear 220, the driving gear 210 is connected to a drive device, and the driven gear 220 is connected to the spray pipe 20. A position detection device is arranged on the driving gear 210 and/or the driven gear 220.

Before the step of controlling the spray pipe 20 to rotate within the preset rotation angle range according to the cleaning mode, the control method further includes: detecting a current deflection angle of the spray pipe 20; comparing the deflection angle with a preset initial angle; and adjusting the deflection angle of the spray pipe 20 when a difference between the current deflection angle and the preset initial angle is greater than zero or less than zero, to make the difference between the current deflection angle and the preset initial angle be zero.

In this embodiment, the initial position is 0 degree when the water spray hole 203 of the spray pipe 20 is oriented vertically upward. There are many ways to detect the current deflection angle of the spray pipe 20, which can be realized through a mechanical structure, or through a sensor or a micro-control switch. That is, the detection device can be a mechanical limiting mechanism, or a pressure sensor, an infrared sensor, an optical sensor or micro-control switch, etc.

The mechanical detection will be first introduced. A limiting block is arranged on a peripheral side of the driving gear 210 and/or the driven gear 220. When the teeth abut against the limiting block, relative rotation of the driving gear 210 and the driven gear 220 stops. The limiting block can be arranged at a position corresponding to the initial position, or at a maximum position of the preset deflection angle range. According to the parameters in the above embodiments, it can be arranged at 0°, 60°, or −60°. The stability of the mechanical detection is very reliable.

The micro-control switch is arranged on a peripheral side of the driving gear 210 and/or the driven gear 220. When the driving gear 210 meshes with the driven gear 220, they squeeze the micro-control switch, and the micro-control switch sends a position signal to a main control circuit of the spraying apparatus. The micro-control switch can be arranged in many positions, for example positions of 0°, 60°, or −60°. Pressure sensors, optical sensors and the like can directly detect the current deflection angle of the spray pipe 20 to directly obtain the deflection angle. Micro-control switches and sensors can get the current deflection angle, which can respond quickly.

After being obtained, the current deflection angle is compared with the preset initial angle. For example, the initial angle is 0°. In some embodiments, the initial position can be set to a non-zero degree, such as 30°, 15°, −15. °, −30° and etc. When the current angle differs from the preset initial angle by 15°, the spray pipe 20 can be deflected by 15° by the drive motor.

It should be noted that the relationship between the deflection angle and deflection speed of the drive motor and the spray pipe 20 will be described by an example below. In this embodiment, the motor adopts a stepping motor, and the deflection speed of the spray pipe 20 is determined by a pulse frequency of the drive motor. The higher the pulse frequency is, the greater the rotation speed of the spray pipe 20 is. The operating angle of the spray pipe 20 is determined by the number of pulses. Different pulse numbers correspond to different operating angles, that is, different deflection angles. The greater the number of pulses is, the larger the deflection angle is (during a single-pass drive). The rotation speed and rotation position of the spray pipe 20 can be controlled by controlling the pulse frequency and the number of pulses of the drive motor.

1. A spraying apparatus, comprising:
a spray pipe provided with a water spray hole; and
a drive device comprising a transmission mechanism and a drive mechanism, wherein the transmission mechanism comprising a driving gear and a plurality of driven gears meshing with the driving gear, the plurality of driven gears are connected to the spray pipe to drive the spray pipe to rotate, and a drive shaft of the drive mechanism is connected to the driving gear to drive the driving gear to rotate.

2. The spraying apparatus according to claim 1, wherein the plurality of driven gears comprise a first driven gear and a second driven gear, and the first driven gear and the second driven gear are configured to mesh with both sides of the driving gear and symmetrically distributed on both sides of the driving gear;
the spray pipe comprises a first spray pipe and a second spray pipe, the first driven gear is connected to the first spray pipe, and the second driven gear is connected to the second spray pipe.

3. The spraying apparatus according to claim 1, wherein a limiting block is arranged on a periphery of the driving gear or the driven gear to define an angle range of deflection of the driven gear and the spray pipe.

4. The spraying apparatus according to claim 1, wherein a micro-control switch is arranged on a periphery of the driving gear or the driven gear and connected to a main control circuit of the spraying apparatus, and the main control circuit is electrically connected to the drive mechanism; or
a pressure sensor is arranged on a periphery of the driving gear and/or the driven gear and connected to a main control circuit of the spraying apparatus, and the main control circuit is electrically connected to the drive mechanism.

5. The spraying apparatus according to claim 1, wherein the drive device further comprises a mounting housing, the mounting housing comprises a front housing and a rear housing, the front housing and the rear housing are detachably connected and are snap-fitted to form a mounting cavity, and the transmission mechanism is arranged within the mounting cavity.

6. The spraying apparatus according to claim 5, wherein positioning posts are arranged on and protrude from an inner wall surface of the front housing close to the rear housing, the driving gear and the plurality of driven gears are provided with mounting holes corresponding to the positioning posts, and the positioning posts are in clearance fit with the mounting holes.

7. The spraying apparatus according to claim 1, wherein the transmission mechanism further comprises a connecting rod; the plurality of driven gears comprise a first driven gear and a second driven gear; and the driving gear, the first driven gear, the connecting rod, and the second driven gear are connected in sequence for transmission;
the spray pipe comprises a first spray pipe and a second spray pipe, the first driven gear is connected to the first spray pipe, and the second driven gear is connected to the second spray pipe.

8. The spraying apparatus according to claim 1, wherein a deflection angle α of the spray pipe is 0˜150°.

9. The spraying apparatus according to claim 1, wherein the spray pipe comprises:
a pipe body having a water intake end and provided with a water spray hole in a pipe wall; and
a water spray groove formed in the spray pipe at a position corresponding to the water spray hole,
wherein the water spray hole is in communication with the water spray groove, and a diameter of the water spray hole is larger than a width of the water spray groove.

10. The spraying apparatus according to claim 9, wherein a ratio of the width l of the water spray groove to the diameter Φ of the water spray hole is 0.18˜0.25; and/or
a ratio of a length L of the water spray groove to the diameter Φ of the water spray hole is greater than or equal to 2.5˜3.5.

11. A control method for a spraying apparatus, wherein the spraying apparatus comprises a spray pipe, and a pipe wall of the spray pipe is provided with a plurality of water spray holes;
the control method comprises:
obtaining a cleaning instruction;
acquiring a cleaning mode according to the cleaning instruction; and
controlling the spray pipe to rotate along an axial axis of the spray pipe within a preset rotation angle range according to the cleaning mode.

12. The control method according to claim 11, wherein controlling the spray pipe to rotate within the preset rotation angle range according to the cleaning mode comprises:
rotating the spray pipe at a first speed within first preset duration since the spray pipe starts working; and
rotating the spray pipe at a second speed within second preset duration after the first preset duration,
wherein the first speed is greater than the second speed.

13. The control method according to claim 11, wherein the preset rotation angle range is equally divided into N cleaning zones in an angular aspect, and controlling the spray pipe to rotate within the preset rotation angle range according to the cleaning mode comprises:
obtaining a current cleaning zone corresponding to the spray pipe;
acquiring preset spray duration at a current location according to the current cleaning zone; and
controlling the spray pipe to be deflected to a next cleaning zone after the preset spray duration in the current cleaning zone.

14. The control method according to claim 13, wherein a cleaning zone corresponding to a water spray hole in a vertically upward direction is a first cleaning zone, and within a preset deflection angle range, a cleaning zone corresponding to a position where an angle between a depth direction of the water spray hole and a vertical direction is largest is a second cleaning zone;
the preset spray duration corresponding to a cleaning zone gradually increases from the first cleaning zone to the second cleaning zone.

15. The control method according to claim 11, wherein controlling the spray pipe to rotate within the preset rotation angle range according to the cleaning mode comprises:
obtaining a preset deflection speed according to a current cleaning mode; and
rotating the spray pipe reciprocally at the preset deflection speed within the preset rotation angle range.

16. The control method according to claim 11, wherein the spraying apparatus further comprises a driving gear and a driven gear, the driving gear is connected to a drive device, the driven gear is connected to the spray pipe, and a position detection device is arranged on the driving gear or the driven gear;
before controlling the spray pipe to rotate within the preset rotation angle range according to the cleaning mode, the control method further comprises:
detecting a current deflection angle of the spray pipe;
comparing a deflection angle with a preset initial angle; and
adjusting the deflection angle of the spray pipe when a difference between the current deflection angle and the preset initial angle is greater than zero or less than zero, to make the difference between the current deflection angle and the preset initial angle be zero.

17. A dishwasher, comprising:
an inner container having a washing cavity; and
a spraying apparatus according to claim 1, the spraying apparatus being mounted within the washing cavity.

18. The dishwasher according to claim 17, wherein the spraying apparatus is configured according to claim 1, and the drive device of the spraying apparatus further comprises a mounting housing, and the transmission mechanism is arranged within the mounting housing.

19. The dishwasher according to claim 18, wherein a plurality of fixing members are arranged on an outer wall of the inner container; the fixing members comprise a first fixing member and a second fixing member spaced apart in a first direction; a plurality of the first fixing members are arranged at intervals in a second direction, and a plurality of the second fixing members are arranged at intervals in the second direction;
the mounting housing is provided with connecting members configured to be fixed to the fixing members; the connecting members are fitted with and fixed to the fixing members; the connecting members comprise a first connecting member and a second connecting member spaced apart in the first direction; a plurality of first connecting members are arranged at intervals in the second direction, and a plurality of second connecting members are arranged at intervals in the second direction;
the first direction is perpendicular to the second direction.

20. The dishwasher according to claim 19, wherein the first fixing member is formed with a mounting groove running through the first fixing member in the first direction; the first connecting member is provided with a guide portion extending along the first direction and protruding from the first connecting member; and the guide portion is configured to be inserted into the mounting groove.
